(19) United States
(12) Patent Application Publication
(10) Pub. No.: US 2010/0257984 A1
(43) Pub. Date: Oct. 14, 2010

(54) PRODUCE PROCESSING APPARATUS

(76) Inventors: David W. Scaroni, Heber, CA (US); Matthew S. Scaroni, Heber, CA (US)

Correspondence Address: KALI LAW GROUP, P. C, P.O. BOX 60187, SUNNYVALE, CA, 94088-0187, US

(21) Appl. No.: 12/421,498

(22) Filed: Apr. 9, 2009

(51) Int. Cl. B26D 1/00; A47J 43/00; B26D 7/06; B26D 7/08; B26D 5/00

(52) U.S. Cl. 83/13; 99/537; 83/422; 83/168; 83/365

(57) ABSTRACT

Produce trimming apparatus are presented including, including: a number of paddles coupled with a rotating conveyor system configured for capturing and isolating the produce along a first section; a counter-rotating compression belt system for compressing the produce along a second section, where the counter-rotating compression belt system is configured to apply a compressive force to the produce such that the produce is secured, and where the counter-rotating compression belt system includes a belt that is counter-rotating and synchronized with respect to the rotating conveyor system; and a cutting system including a number of cutting blades positioned along a path of the rotating conveyor system, where the number of cutting blades are configured to core and trim the produce along the second section.

### BACKGROUND

Embodiments of the present invention relate to methods and apparatus for harvesting produce. In particular, methods may be utilized for automated trimming and coring operations.

Modern farming techniques provide many automated methods for harvesting produce. Automated methods have resulted in more efficient utilization of farming resources. For example, automated methods have increased uniformity and quality in produce processing while simultaneously reducing the number of personnel required for accomplishing that production. As a result of automation, delivery of plentiful and low cost products to market is made possible.

In some farming processes, however, some manual labor is still required. For example, in harvesting delicate produce such as leafy vegetables—hand picking, sorting, and processing is still being utilized in field. In a typical field, numerous personnel are required to maintain harvesting production. As may be appreciated, the costs associated with managing large workforces directly affect market prices. In addition, human error and inconsistency may result, in some examples, in non-uniform production which could adversely affect consumer satisfaction.

At least one problem associated with harvesting delicate produce automatically is that the produce may be easily damaged. For example, lettuce is one type of delicate produce. During production, lettuce must be sufficiently secured without damaging the leaves which is the end product. In many cases, field processing may be desirable to lower overall production costs, however, equipment must be both sufficiently robust to handle field environments as well as sufficiently sensitive to handle produce without damage—two goals which are often in direct opposition with one another.

Another problem in harvesting delicate produce automatically is that selection of viable produce is critical. Typically, a laborer examines a head of lettuce to determine whether the produce is viable as a market product. The laborer may then accept or reject the produce before harvesting. However, viability is necessarily a subjective assessment and is thus continually subject to human error. As may be appreciated, these errors may lead either to non-viable product reaching market, or viable product being lost in the field.

As such produce processing apparatus are presented herein.

### SUMMARY

The following presents a simplified summary of some embodiments of the invention in order to provide a basic understanding of the invention. This summary is not an extensive overview of the invention. It is not intended to identify key/critical elements of the invention or to delineate the scope of the invention. Its sole purpose is to present some embodiments of the invention in a simplified form as a prelude to the more detailed description that is presented below.

As such, produce trimming apparatus are presented including, including: a number of paddles coupled with a rotating conveyor system configured for capturing and isolating the produce along a first section; a counter-rotating compression belt system for compressing the produce along a second section, where the counter-rotating compression belt system is configured to apply a compressive force to the produce such that the produce is secured, and where the counter-rotating compression belt system includes a belt that is counter-rotating and synchronized with respect to the rotating conveyor system, and a cutting system including a number of cutting blades positioned along a path of the rotating conveyor system, where the number of cutting blades are configured to core and trim the produce along the second section. In some embodiments, apparatus further include: a rinse system along a third section for rinsing a trimmed and cored produce, where the rinse system includes a rinse selected from the group consisting of: a water rinse, a saline rinse, a chemical rinse, and an air rinse. In some embodiments, apparatus further include: a first optical detection device along the first section for detecting viability of the produce, the optical detection device configured to function in coordination with a first produce rejection system along the first section, where the produce is removed from the rotating conveyor system if the produce is not viable; and a second optical detection device along the third section for detecting viability of the produce, the optical detection device configured to function in coordination with a second produce rejection system where the produce is removed from the rotating conveyor system if the produce is not viable. In some embodiments, the produce includes: a romaine lettuce head, an iceberg lettuce head, a butterhead lettuce head, a summertime lettuce head, a cabbage head, a bok choy head, an escarole lettuce head, a radicchio lettuce heat, a broccoli head, a cauliflower head, a broccoflower head, a celery bunch, and a carrot bunch. In some embodiments, the paddles are configured in a shape such as: a planar shape, a multi-planar shape, an arcuate shape, a semi-arcuate shape, and a cupped shape and the number of cutting blades include: a rotating blade, a linear action blade, a static blade, a metal wire blade, a laser blade, and a water blade.

In other embodiments, methods for coring and trimming a produce are presented including: receiving a severed produce on a rotating conveyor system along a first section, the rotating conveyor system including a number of paddles for capturing and isolating the severed produce; compressing the severed produce with a counter-rotating compression belt system configured to apply a compressive force to the severed produce such that the severed produce is secured; and transporting the severed produce through a cutting system including a number of cutting blades configured to trim and core the severed produce; and releasing a trimmed and cored produce to a collection point. In some embodiments, methods include optically detecting viability of the severed produce before the compressing the severed produce; and rejecting the severed produce if the severed produce is not viable. In some embodiments, methods further include rinsing the trimmed and cored severed produce, where the rinsing includes a rinse such as: a water rinse, a saline rinse, a chemical rinse, and an air rinse.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is an illustrative representation of a perspective view of a produce processing apparatus in accordance with embodiments of the present invention;

FIG. 2 is an illustrative flowchart of methods for processing produce in accordance with embodiments of the present invention;

FIGS. 3A-B are illustrative representations of side views of a produce processing apparatus during processing in accordance with embodiments of the present invention;

FIG. 4 is an illustrative representation of a unit of processed produce in accordance with embodiments of the present invention; and

FIG. 5 is an illustrative representation of various paddle shapes in accordance with embodiments of the present invention.

### DETAILED DESCRIPTION

The present invention will now be described in detail with reference to a few embodiments thereof as illustrated in the accompanying drawings. In the following description, numerous specific details are set forth in order to provide a thorough understanding of the present invention. It will be apparent, however, to one skilled in the art, that the present invention may be practiced without some or all of these specific details. In other instances, well known process steps and/or structures have not been described in detail in order to not unnecessarily obscure the present invention.

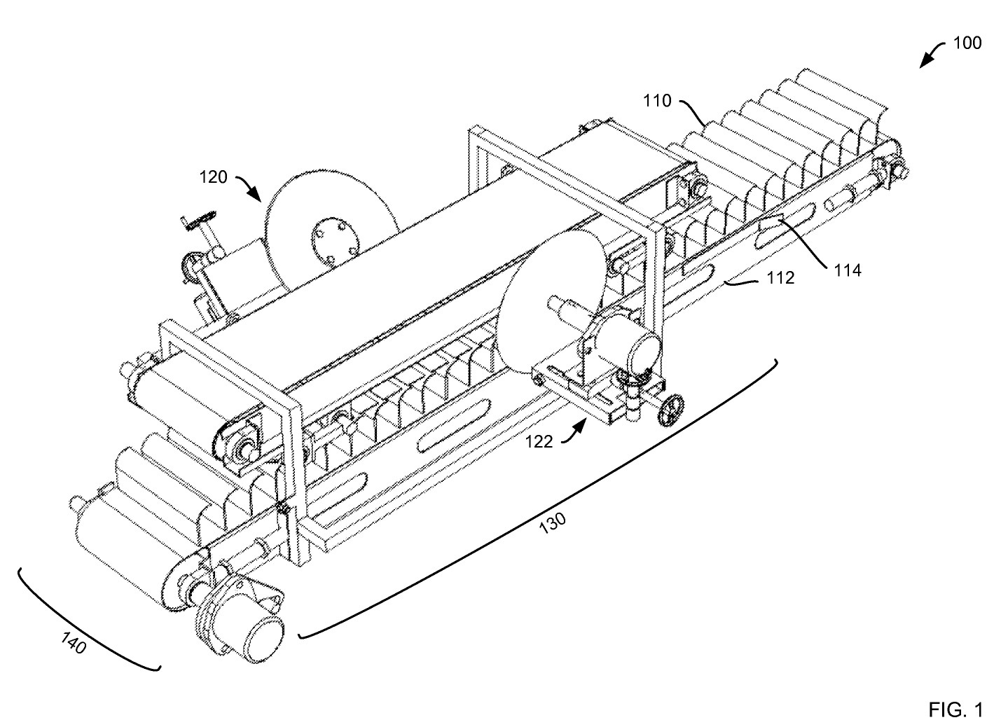

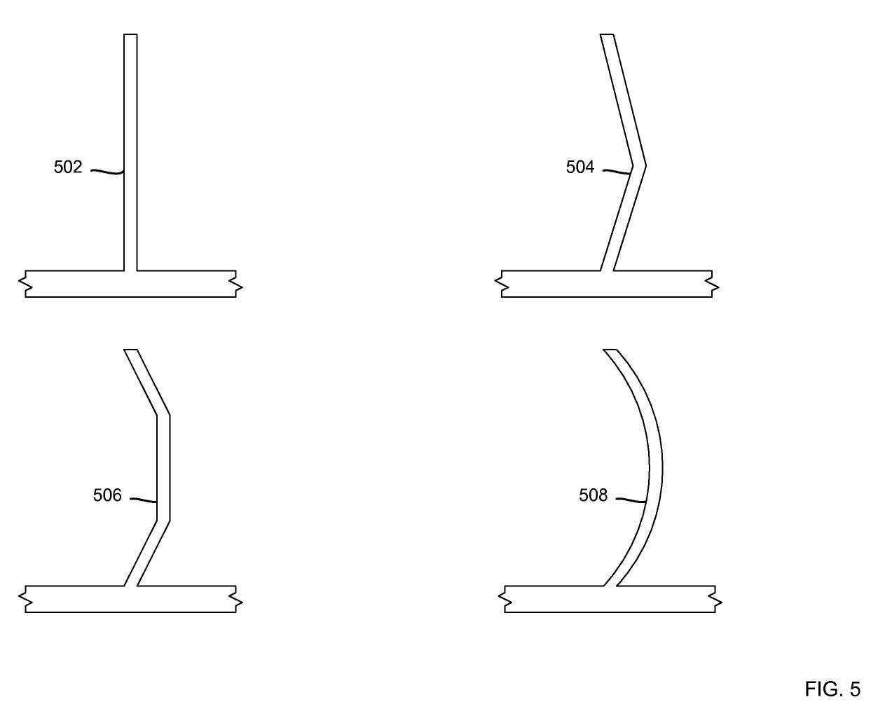

FIG. 1 is an illustrative representation of a perspective view of a produce processing apparatus 100 in accordance with embodiments of the present invention. In particular, FIG. 1 is provided to illustrate the various systems required for processing apparatus 100. As such, processing apparatus 100 includes a plurality of paddles 110 for capturing and isolating severed produce. As illustrated, paddles may be configured, in some embodiments, having a semi-arcuate shape. Referring briefly to FIG. 5, which is an illustrative representation of various paddle shapes in accordance with embodiments of the present invention, it may be seen that a variety of shapes may be utilized to capture produce. For example, a planar shape 502, a multi-planar shape 504 and 506, an arcuate shape 508, and a cupped shape (not shown) may be utilized without departing from the present invention. Different shapes of paddles may be desirable in processing different types of produce. For example, in embodiments, produce such as a romaine lettuce head, an iceberg lettuce head, a butterhead lettuce head, a summertime lettuce head, a cabbage head, a bok choy head, an escarole lettuce head, a radicchio lettuce heat, a broccoli head, a cauliflower head, a broccoflower head, a celery bunch, and a carrot bunch may be processed utilizing different shaped paddles without limitation. Furthermore, paddles, as utilized herein, may be manufactured from a flexible or semi-flexible polymeric compound in some embodiments. As may be appreciated, a clean and sanitary environment is desirable in food processing systems. As such, some polymeric compounds, such as polyurethane may be useful in providing a sanitary capture device. In other embodiments, a stainless steel paddle may be provided. It may be noted that the illustrated embodiments in FIG. 5 are provided for clarifying embodiments and should not be construed as limiting with respect to dimension, shape, or material.

Returning to FIG. 1, produce processing apparatus 100 further includes a conveyor system 112, which may be utilized for moving produce the various systems. Any conveyor system known in the art may be utilized without departing from the present invention. In addition, conveyance systems may be powered by drives such as: an internal combustion engine, an electric motor, a compressed air motor, a hydraulic fluid motor, a wind turbine motor, and a power take off (PTO) motor without limitation and without departing from the present invention. Produce processing apparatus 100 may be further configured with alignment bar 114 for aligning a produce head in order to properly and accurately process the produce.

Produce processing apparatus 100 may be further configured with counter-rotating compression belt system 130. Counter-rotating compression belt system 130 may be configured to apply a compressive force to produce in order to secure the produce. Sufficient compressive forces should be applied to secure the produce without damaging the produce. As may be appreciated, different produce will require different compressive force to obtain production objectives. For example, a head of leafy produce may require less compressive force than a head of dense produce such as broccoli. As such, counter-rotating compression belt system 130 may be configured with an adjustment mechanism for adjusting compressive forces in some embodiments. In some embodiments, a compressive force in a range of approximately 1 to 40 pounds of downward force may be applied to produce by counter-rotating compression belt system 130. In addition, it may be desirable, in some embodiments, to increase compressive force on produce to account for loss of produce material during processing. As such, compressive force may be increased from a first compressive force in a range of approximately 1 to 40 pounds of downward force to a second compressive force in a range of approximately 5 to 60 pounds of downward force.

Counter-rotating compression belt system 130 may also be configured to move synchronously with conveyor system 112. Synchronous movement ensures that produce may be stabilized for processing. However, in other embodiments, asynchronous movement may be desired when processing requires some rotation of the produce. In those asynchronous embodiments, one or more counter-rotating compression belt systems may be utilized to alternately stabilize and rotate produce. Belts utilized in counter-rotating compression belt systems may be manufactured from a flexible or semi-flexible polymeric compound in some embodiments. As may be appreciated, a clean and sanitary environment is desirable in food processing systems. As such, some polymeric compounds, such as polyurethane or TEFLON™ may be useful in providing a belt for use in counter-rotating compression belt systems without limitation. In other embodiments, a non-corrosive metal belt such as stainless steel belt may be provided without limitation. In other embodiments, a metal coated belt may be provided without limitation. In still other embodiments, a rubber or rubberized belt may be provided without limitation. As above, counter-rotating compression belt systems may be powered by drives such as: an internal combustion engine, an electric motor, a compressed air motor, a hydraulic fluid motor, a wind turbine motor, and a power take off (PTO) motor without limitation and without departing from the present invention. In some embodiments, counter-rotating compression belt systems may be mechanically linked to conveyor systems by means of a gear box or chain such that coordinated movement of the systems may be readily achieved.

Produce processing apparatus 100 may be further configured with a cutting system including a number of cutting blades 120 and 122 for coring and trimming produce. As illustrated blades 120 and 122 are rotating blades. Rotating blades may have some advantages over other methods of processing because blades may be easily serviced to provide clean coring and trimming. In some embodiments, rotating blades may further include a safety shroud (not shown) in order to provide a safe working environment for operators of produce processing apparatus 100. However, in some embodiments, other methods of coring and trimming may be utilized. For example, in some embodiments, a linear action blade, a static blade, a metal wire blade, a laser blade, and a water blade may be utilized without departing from the present invention. As above, counter-rotating cutting blades may be powered by drives such as: an internal combustion engine, an electric motor, a compressed air motor, a hydraulic fluid motor, a wind turbine motor, and a power take off (PTO) motor without limitation and without departing from the present invention.

Produce processing apparatus 100 may be further configured with a rinse system (not shown). It may be appreciated that rinsing produce after processing may be desirable to remove cull or other debris such as insects and soil. Thus, any rinse system known in the art may be utilized without departing from the present invention. In addition, any type of rinse may be utilized including a water rinse, a saline rinse, a chemical rinse, and an air rinse without departing from the present invention.

As produce production becomes more automated, methods of detecting viable produce may be required. In some embodiments, an optical detection device may be utilized to determine viability. These devices may be used before processing when produce is captured by produce processing apparatus 100, after produce is processed by produce processing apparatus 100, or both in some embodiments. Utilization of an optical detection device may improve and assure quality control in some embodiments. As such, any optical detection device known in the art may be utilized without departing from the present invention. In addition, a produce rejection system may be utilized in coordination with an optical detection device to remove produce from produce processing apparatus when the produce is not viable. In some embodiments, a produce rejection system may mechanically eject produce from the apparatus. In other embodiments, an alarm may inform an operator that produce is not viable. In still other embodiments, a log may be recorded to track rejected produce.

When processing is complete, produce may be released from produce processing apparatus 100 at a collection point 140. At that point, produce may be processed or transported in any number of ways. It may be appreciated that by produce processing apparatus 100 may be utilized in the field or out of field without departing from the present invention. Furthermore, embodiments of produce processing apparatus 100 may be truck mounted, trailer mounted, boom mounted, or tractor mounted without limitation. Still further, embodiments may be utilized in coordination with other automated production machinery such as a harvesting machine without limitation.

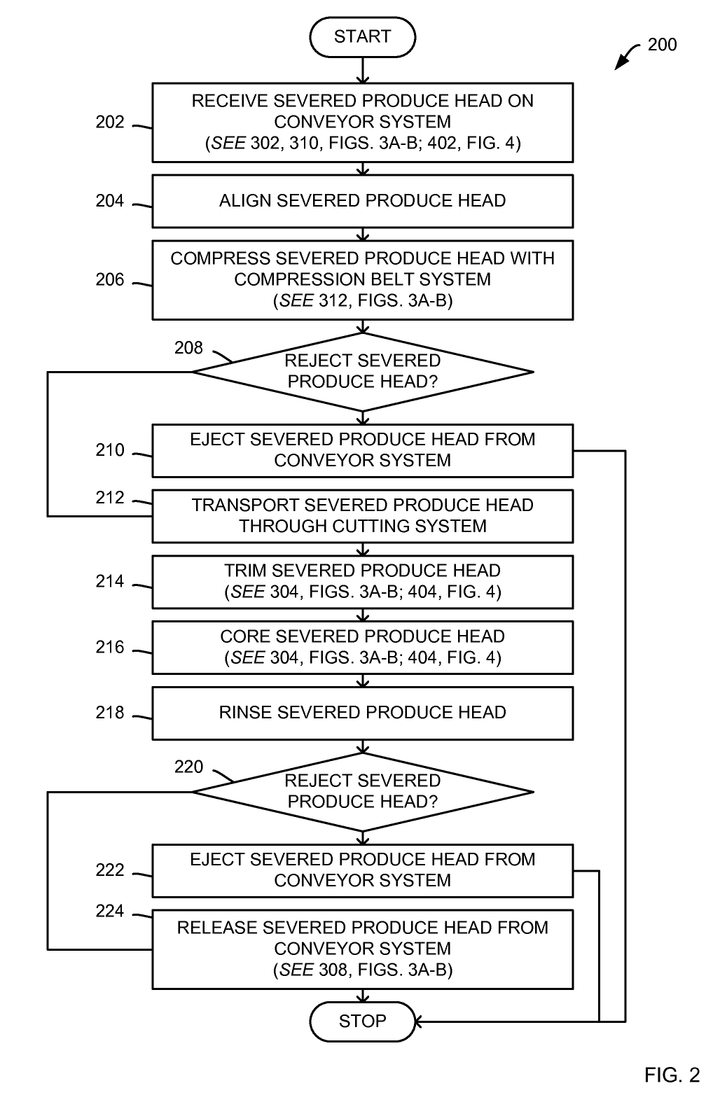

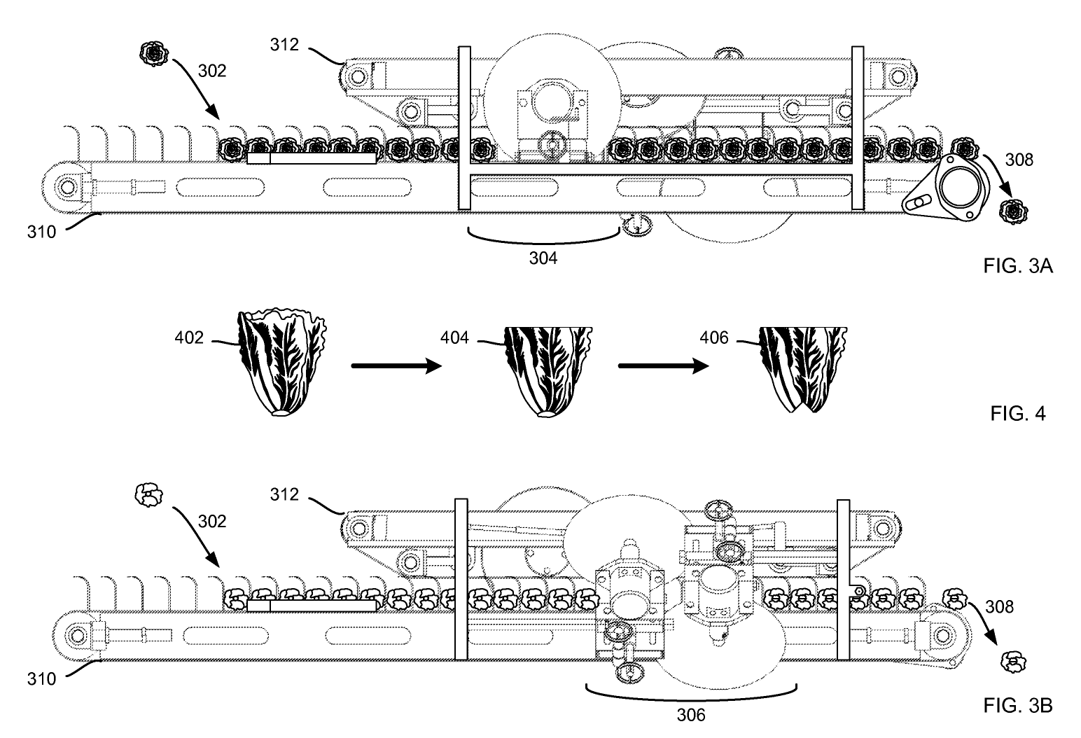

FIG. 2 is an illustrative flowchart 200 of methods for processing produce in accordance with embodiments of the present invention. FIG. 2 will be discussed with FIGS. 3A-B, which are illustrative representations of side views of a produce processing apparatus during processing in accordance with embodiments of the present invention and with FIG. 4, which is an illustrative representation of a unit of processed produce in accordance with embodiments of the present invention. At a first step 202, the method receives a severed produce head on a rotating conveyor system. A severed produce head may be received from automated harvesting machinery or from harvesting personnel without limitation. Referring briefly to FIGS. 3A-B and 4, a produce head 402 is received by rotating conveyor system 310 at 302. As illustrated, each produce head is isolated. Returning to FIG. 2, at a next step 204, produce head is aligned. As noted above, produce processing apparatus embodiments may be configured with an alignment bar for aligning a produce head in order to properly and accurately process the produce. In some embodiments alignment may be manually achieved by operators.

At a next step 206, the severed head may be captured by a counter-rotating compression belt system (see 312, FIGS. 3A-B). As noted above, counter-rotating compression belt systems may be configured to move synchronously with conveyor systems. Synchronous movement ensures that produce may be stabilized for processing. However, in some embodiments, asynchronous movement may be desired when processing requires some rotation of the produce. At a next step 208, the method determines whether to reject a severed produce head. As noted above, optical detection systems may be utilized in some embodiments to detect viability of produce. In some embodiments, produce may be inspected by an operator. Therefore, if the method determines at a step 208 to reject a severed produce head, the method continues to a step 210 to eject the severed produce head from the conveyor system whereupon the method ends. If the method determines at a step 208 not to reject a severed produce head, the method continues to a step 212 to transport the severed produce head through a cutting system.

At a next step 214, the method trims the severed produce head (see 304, FIGS. 3A-B, 404 FIG. 4). Trimming, as utilized herein removes a top portion of a head. The removed portion is called cull. Trimming may be adjustably configured to remove any amount of cull from the severed head depending on production requirements. Typically, processing removes only portions that may be unsightly or undesirable to a consumer. In some embodiments, trimming removes additional cull by making an angled cut to remove a side portion with respect to the top of the severed head. At a next step 216, the method cores the severed produce head (see 306, FIGS. 3A-B; 406 FIG. 4). Coring, as utilized herein, refers to removal of a bottom portion of the head. As above, the removed portion is called cull. Coring may be adjustably configured to remove any amount of cull from the severed head depending on production requirements. In some embodiments, a core may be removed leaving a “V” shaped cut. In other embodiments, a core may be removed leaving a straight cut. In still other embodiments, a core may be removed leaving a semi-arcuate or arcuate cut. As noted above, rotating blades, as illustrated here, may have some advantages over other methods of processing because blades may be easily serviced to provide clean coring and trimming. In some embodiments, rotating blades may further include a safety shroud in order to provide a safe working environment for operators of produce processing apparatus. However, in some embodiments, other methods of coring and trimming may be utilized. For example, in some embodiments, a linear action blade, a static blade, a metal wire blade, a laser blade, and a water blade may be utilized without departing from the present invention.

It may be appreciated that trimming and coring requirements may depend in part upon the type of produce being processed. As noted above, a number of types of produce may be processed utilizing methods described herein. For example, in embodiments, produce such as a romaine lettuce head, an iceberg lettuce head, a butterhead lettuce head, a summertime lettuce head, a cabbage head, a bok choy head, an escarole lettuce head, a radicchio lettuce heat, a broccoli head, a cauliflower head, a broccoflower head, a celery bunch, and a carrot bunch may be processed without limitation.

At a next step 218, the method rinses a trimmed and cored produce head. It may be appreciated that rinsing produce after processing may be desirable to remove cull or other debris such as insects and soil. Thus, any rinse system known in the art may be utilized without departing from the present invention. In addition, any type of rinse may be utilized including a water rinse, a saline rinse, a chemical rinse, and an air rinse without departing from the present invention. At a next step 220, the method determines whether to reject a trimmed and cored produce head. As noted above, optical detection systems may be utilized in some embodiments to detect viability of produce. In some embodiments, produce may be inspected by an operator. Therefore, if the method determines at a step 220 to reject a trimmed and cored produce head, the method continues to a step 222 to eject the trimmed and cored produce head from the conveyor system whereupon the method ends. If the method determines at a step 220 not to reject a trimmed and cored produce head, the method continues to a step 224 to release the trimmed and cored produce head to a collection point.

While this invention has been described in terms of several embodiments, there are alterations, permutations, and equivalents, which fall within the scope of this invention. It should also be noted that there are many alternative ways of implementing the methods and apparatuses of the present invention. Furthermore, unless explicitly stated, any method embodiments described herein are not constrained to a particular order or sequence. For example, trimming and coring may be performed in any order without departing from the present invention. Still further, optical scanning of produce may be performed at any stage during production. Further, the Abstract is provided herein for convenience and should not be employed to construe or limit the overall invention, which is expressed in the claims. It is therefore intended that the following appended claims be interpreted as including all such alterations, permutations, and equivalents as fall within the true spirit and scope of the present invention.

What is claimed is:

1. A produce trimming apparatus, comprising:
a plurality of paddles coupled with a rotating conveyor system configured for capturing and isolating the produce along a first portion,
a counter-rotating compression belt system for compressing the produce along a second portion, wherein the counter-rotating compression belt system is configured to apply a compressive force to the produce such that the produce is secured, and wherein the counter-rotating compression belt system includes a belt that is counter-rotating and synchronized with respect to the rotating conveyor system; and
a cutting system comprising a plurality of cutting blades positioned along a path of the rotating conveyor system, wherein the plurality of cutting blades are configured to core and trim the produce along the second portion.

2. The apparatus of claim 1, further comprising:
a rinse system along a third portion for rinsing a trimmed and cored produce.

3. The apparatus of claim 2, wherein the rinse system includes a rinse selected from the group consisting of: a water rinse, a saline rinse, a chemical rinse, and an air rinse.

4. The apparatus of claim 2, further comprising:
a first optical detection device along the first portion for detecting viability of the produce, the optical detection device configured to function in coordination with a first produce rejection system along the first portion, wherein the produce is removed from the rotating conveyor system if the produce is not viable.

5. The apparatus of claim 4, further comprising:
a second optical detection device along the third portion for detecting viability of the produce, the optical detection device configured to function in coordination with a second produce rejection system wherein the produce is removed from the rotating conveyor system if the produce is not viable.

6. The apparatus of claim 1, further comprising:
an alignment bar for aligning the produce with the rotating conveyor system along the first portion.

7. The apparatus of claim 1, wherein the counter-rotating compression belt system is configured to apply the compressive force to the produce such that the compressive force is increased from a first compressive force to a second compressive force.

8. The apparatus of claim 1, wherein the counter-rotating compression belt system, the rotating conveyor system, and the plurality of cutting blades are driven by at least one drive selected from the group consisting of: an internal combustion engine, an electric motor, a compressed air motor, a hydraulic fluid motor, a wind turbine motor, and a power take off (PTO) motor.

9. The apparatus of claim 1, wherein the produce is selected from the group consisting of:
a romaine lettuce head, an iceberg lettuce head, a butterhead lettuce head, a summertime lettuce head, a cabbage head, a bok choy head, an escarole lettuce head, a radicchio lettuce heat, a broccoli head, a cauliflower head, a broccoflower head, a celery bunch, and a carrot bunch.

10. The apparatus of claim 1, wherein the paddles are configured in a shape selected from the group consisting of: a planar shape, a multi-planar shape, an arcuate shape, a semi-arcuate shape, and a cupped shape.

11. The apparatus of claim 1, wherein the plurality of cutting blades is selected from the group consisting of: a rotating blade, a linear action blade, a static blade, a metal wire blade, a laser blade, and a water blade.

12. A method for coring and trimming a produce, the method comprising:
receiving a severed produce on a rotating conveyor system along a first portion, the rotating conveyor system comprising a plurality of paddles for capturing and isolating the severed produce;
compressing the severed produce with a counter-rotating compression belt system configured to apply a compressive force to the severed produce such that the severed produce is secured; and
transporting the severed produce through a cutting system comprising a plurality of cutting blades configured to trim and core the severed produce; and
releasing a trimmed and cored produce to a collection point.

13. The method of claim 12, further comprising:
aligning the severed produce with the rotating conveyor system along the first portion.

14. The method of claim 12, further comprising:
optically detecting viability of the severed produce before the compressing the severed produce; and
rejecting the severed produce if the severed produce is not viable.

15. The method of claim 14, further comprising:
optically detecting viability of the trimmed and cored produce after the transporting the severed produce through a cutting system; and
rejecting the trimmed and cored produce if the trimmed and cored produce is not viable.

16. The method of claim 12, further comprising rinsing the trimmed and cored severed produce, wherein the rinsing includes a rinse selected from the group consisting of: a water rinse, a saline rinse, a chemical rinse, and an air rinse.

17. The method of claim 12, wherein the plurality of cutting blades includes at least two cutting blades configured to remove the core with a “V” shaped cut.

18. The method of claim 12, wherein the plurality of cutting blades is selected from the group consisting of: a rotating blade, a linear action blade, a static blade, a metal wire blade, a laser blade, and a water blade.

19. The method of claim 12, wherein the cutting system includes at least one cutting blade configured to trim the produce wherein the trim removes at least a top portion and at least a side portion of the produce.

20. The method of claim 12, wherein the produce is selected from the group consisting of: a romaine lettuce head, an iceberg lettuce head, a butterhead lettuce head, a summertime lettuce head, a cabbage head, a bok choy head, an escarole lettuce head, a radicchio lettuce heat, a broccoli head, a cauliflower head, a broccoflower head, a celery bunch, and a carrot bunch.
